(19) United States
(12) Patent Application Publication
(10) Pub. No.: US 2010/0066044 A1
(43) Pub. Date: Mar. 18, 2010

(54) BABY CARRIAGE HAVING STEERING DEVICE

(76) Inventor: Gyung Hwan Kim, Gyeonggi-do (KR)

Correspondence Address: Muncy, Geissler, Olds & Lowe, PLLC, P.O. BOX 1364, FAIRFAX, VA, 22038-1364, US

(21) Appl. No.: 12/513,528

(22) PCT Filed: Oct. 29, 2007
(86) PCT No.: PCT/KR2007/005346

§ 371 Date: May 5, 2009

(30) Foreign Application Priority Data
Nov. 8, 2006 (KR) 10-2006-0110155

(51) Int. Cl. B62B 3/00; F16D 3/00

(52) U.S. Cl. 280/47.11; 403/57

(57) ABSTRACT

A baby carriage having a steering device is disclosed. The baby carriage includes a pair of handles manipulated by a user to generate rotating force for steering. A pair of steering wheels is rotated in conjunction with the handles to steer and move the baby carriage. Further, a pair of steering devices transmits the rotating force from the handles to the steering wheels. Each steering device includes a vertical steering shaft coupled to each steering wheel, an inclined rotating shaft, a steering joint transmitting rotating force from the inclined rotating shaft to the vertical steering shaft, and a shock absorbing part absorbing an external force acting on each steering wheel, thus enabling a baby riding in the baby carriage to be stably moved.

### TECHNICAL FIELD

The present invention relates, in general, to a baby carriage having a steering device and, more particularly, to a baby carriage having a steering device, which includes a pair of handles manipulated by a user to generate rotating force for steering, a pair of steering wheels rotated in conjunction with the handles and used to steer and move the baby carriage, and a pair of steering devices transmitting the rotating force from the handles to the steering wheels. Each of the steering devices includes a vertical steering shaft coupled to each of the steering wheels, an inclined rotating shaft coupled at a first end thereof to each of the handles and coupled at a second end thereof to the vertical steering shaft while being inclined relative to the vertical steering shaft at a predetermined inclination angle, a steering joint transmitting rotating force from the inclined rotating shaft to the vertical steering shaft, so that each of the steering wheels is steered, and a shock absorbing part absorbing an external force acting on each of the steering wheels, thus enabling a baby riding in the baby carriage to be stably moved.

### BACKGROUND ART

Generally, a baby carriage is a small vehicle for carrying a baby. The baby carriage, as well as a baby carrier or a baby-walker, is an article which is essential in order to care for an infant or baby under 5 years of age, and has been widely used in many homes. Unlike the baby carrier, which is wrapped around an adult's body to carry a baby when taking the baby outdoors or when traveling, and the baby walker, which is mainly used in a room and has wheels at predetermined positions on a chassis to help a baby move itself, the baby carriage is a useful transport means that is movable by a guardian's external force applied to the baby carriage, in which a baby rides, thus reducing the effort required by the guardian.

Such a conventional baby carriage includes a cradle seat which accommodates a baby, a handle which is grasped by a guardian in order for him or her to apply external force to the baby carriage, and wheels which rotate when the guardian applies external force to the baby carriage. When a guardian grasps the handle and applies external force to the baby carriage so as to move it in a desired direction with the baby riding in the baby carriage, the wheels rotate, and consequently the baby carriage moves.

However, the conventional baby carriage is problematic in that it has no steering device, so that, when a guardian desires to change the direction of travel of the baby carriage, the same magnitude of force is not applied by both hands, but a larger pushing force must be applied by the hand that is located at a side opposite to a desired traveling direction, and simultaneously pulling force must be applied to the hand that is located in the desired traveling direction. Therefore, it is difficult to steer the baby carriage.

Further, a considerable magnitude of external force is required in order to steer the baby carriage in a desired traveling direction. However, since a woman generally uses the baby carriage, it is difficult for the woman to control external force, in consideration of both the weight of the baby carriage and the baby's weight, so as to change the traveling direction.

Further, when the baby carriage moves on a rough road, the conventional baby carriage has no steering device, and thus it is possible to steer the baby carriage only by controlling the force applied by a guardian. Meanwhile, in the case where the baby carriage is provided only with a shock absorbing device without considering a steering function, the wheels of the baby carriage may move in an unintended direction when the shock absorbing device is operated during a steering operation. Such an unintended movement results in a collision between the wheels of the baby carriage and an area having a step, or the shaking of the baby carriage, thus reducing the shock absorbing effect. Therefore, it is difficult to stably move a baby, who is very sensitive to the external environment.

### DISCLOSURE OF INVENTION

### Technical Problem

Accordingly, the present invention has been made keeping in mind the above problems occurring in the prior art, and an object of the present invention is to provide a baby carriage having a steering device, which has a steering function, thus allowing a guardian to easily steer the baby carriage in a desired direction when taking a baby outdoors or traveling.

Another object of the present invention is to provide a baby carriage having a steering device, which is capable of controlling the traveling direction of the baby carriage using a small force, thus allowing even a woman to easily steer the baby carriage.

A further object of the present invention is to provide a baby carriage having a steering device, which is provided with a shock absorbing device suitable for the baby carriage, thus enabling easy steering operation and efficiently absorbing vibration or shocks applied to the baby carriage when it moves on a rough road, therefore allowing only a minimum of vibration and shocks to be transferred to a baby riding in the baby carriage, and stably moving the baby, who is sensitive to the external environment.

Yet another object of the present invention is to provide a baby carriage having a steering device, which is constructed so that the central axis of a shock absorbing device for absorbing vibrations or shocks acting on the baby carriage is spaced apart from the central axis of each wheel, and thus the operation of the shock absorbing device does not affect the operation of steering the baby carriage.

Still another object of the present invention is to provide a baby carriage having a steering device, which balances different rotating forces and rotating angles, transmitted to a pair of wheels coupled to the steering device, so that the rotating forces and the rotating angles are uniform, when there is a difference in the rotating force and the rotating angle between the two hands that manipulate the baby carriage to steer it, thus achieving more stable steering operation.

### Technical Solution

In order to accomplish the above objects, the present invention provides a baby carriage having a steering device, which is constructed as follows.

According to the first embodiment of this invention, the baby carriage having a steering device, includes a pair of handles manipulated by a user to generate rotating force for steering, a pair of steering wheels rotated in conjunction with the handles and used to steer and move the baby carriage, and a pair of steering devices transmitting the rotating force from the handles to the steering wheels, wherein each of the steering devices includes a vertical steering shaft coupled to each of the steering wheels, an inclined rotating shaft coupled at a first end thereof to each of the handles, and coupled at a second end thereof to the vertical steering shaft while being inclined relative to the vertical steering shaft at a predetermined inclination angle, a steering joint transmitting rotating force from the inclined rotating shaft to the vertical steering shaft, so that each of the steering wheels is steered, and a shock absorbing part absorbing an external force acting on each of the steering wheels, thus enabling a baby riding in the baby carriage to be stably moved.

According to the second embodiment of the present invention, the steering device includes a steering body including a holding cavity provided in a predetermined portion of the steering body to accommodate the shock absorbing part therein, and a central shaft provided at a predetermined position around the holding cavity and coupled to a central axis of the shock absorbing part, and a coupling part coupled at a first side thereof to the holding cavity via a coupling projection, and coupled at a second side thereof to the central shaft, so that, when external force is applied to the steering device, the coupling part rotates and compresses the shock absorbing part to absorb the external force.

According to the third embodiment of the present invention, the coupling part includes a pressure coupling hole coupled to the coupling projection, a central-shaft coupling hole coupled to the central shaft, and a wheel coupling member coupled to the steering wheel, the wheel coupling member being spaced apart from the central-shaft coupling hole by a predetermined distance so that, when external force is applied to the steering device, the wheel coupling member rotates and reduces a distance by which it is spaced apart from the vertical steering shaft.

According to the fourth embodiment of the present invention, the shock absorbing part includes an elastic member having elastic force to absorb external force transmitted through the coupling part, a support plate supporting an end of the elastic member to press the elastic member, and a pressure member coupled to the coupling part via the coupling projection and moving along with the coupling part to press the support plate.

According to the fifth embodiment of the present invention, the steering body further includes a compensating plate coupled to a rotation compensating frame which balances different rotating forces transmitted to the respective steering wheels so that the pair of steering wheels rotates at the same rotating angle.

According to the sixth embodiment of the present invention, the baby carriage further includes a support frame on which a baby riding in the baby carriage puts its feet, the support frame preventing the steering device from being exposed to the outside, thus providing a good appearance.

According to the seventh embodiment of the present invention, the steering device further includes a clamping part through which the vertical steering shaft passes, the clamping part rotatably supporting the steering body.

According to the eighth embodiment of the present invention, the steering body includes a connection hole into which a steering-shaft connection pin is inserted, so that the steering body rotates in conjunction with the vertical steering shaft.

According to the ninth embodiment of the present invention, the steering body includes a rotation transmitting cylinder used to transmit rotating force from the handle through the coupling part to the steering wheel, the coupling part including a rotary support member supported by the rotation transmitting cylinder, the rotary support member further including a catch prevention plate to prevent the rotation transmitting cylinder from being caught by the rotary support member when the coupling part moves during a shock absorbing operation.

According to the tenth embodiment of the present invention, the steering joint comprises a universal joint.

### ADVANTAGEOUS EFFECTS

The present invention accomplishes the following effects through the aforementioned construction and operation.

According to the present invention, when a baby goes out or travels while riding in a baby carriage, it is easy to steer the baby carriage in a desired direction, and it is possible to control the traveling direction of the baby carriage using even a small force, thus allowing even a woman to easily steer the baby carriage, therefore making use thereof convenient.

According to the present invention, even when the baby carriage moves on a rough road, some of the vibrations or shocks acting on the baby carriage are absorbed, so that a minimum of vibration and shocks are transmitted to a baby riding in the baby carriage, thus ensuring stable movement of the baby, who is sensitive to the external environment.

According to the present invention, vibration or shocks, transmitted from handles or the road to the baby carriage, can be absorbed, and such a shock absorbing operation hardly affects a steering operation, thus realizing easy steering operation and efficient shock absorbing operation.

According to the present invention, even when a user applies different rotations with both hands, the different rotations, transmitted to respective wheels, are balanced and thus made uniform, so that the user can steer the baby carriage more stably.

### BRIEF DESCRIPTION OF THE DRAWINGS

FIG. 1 is a perspective view showing a baby carriage having a steering device, according to the present invention;

FIG. 2 is an exploded perspective view of portion A, circled in FIG. 1, to show the steering device according to the present invention;

FIG. 3 is a perspective view showing a steering part and a coupling part of the baby carriage, according to the present invention, in which the steering part is coupled with the coupling part;

FIG. 4 is a schematic view showing a shock absorbing state according to an embodiment of the present invention, when the central axes of a shock absorbing part and a steering wheel are on the same line;

FIG. 5 is a schematic view showing a shock absorbing state according to another embodiment of the present invention, when the central axes of a shock absorbing part and a steering wheel are spaced apart from each other by a predetermined distance;

FIG. 6 is a plan view showing one use of the steering device, according to the present invention;

FIG. 7 is a plan view showing another use of the steering device, according to the present invention;

FIG. 8 is a plan view showing a further use of the steering device, according to the present invention;

FIG. 9 is a schematic view showing the state before the shock absorbing part of the present invention is operated;

FIG. 10 is a schematic view showing the operational state when the shock absorbing part of the present invention is compressed upwards; and

FIG. 11 is a schematic view showing the operational state when the shock absorbing part of the present invention is compressed downwards.

### DESCRIPTION OF REFERENCE CHARACTERS OF IMPORTANT PARTS

1: baby carriage having steering device according to the present invention 2: handles 3: steering devices
4: support frame 5: steering wheels 6: side frames 7: sun shade 8: cradle seat 9: auxiliary wheels 10: steering-shaft connection pin 11: coupler 12: fastener
13: connection bar 14: axle 15: ground 21: left handle 22: right handle 31: steering transmission part
32: steering body 32a: upper body part 32b: front body part 32c: rear body part 32d: end 32e: opening
33: shock absorbing part 34: coupling part 34a: body
34b: first end 34c: sidewall 34d: second end
34e: rear wall 34f: space 35: clamping part 35a: body 35b: upper plate 35c: lower plate 35d: opening
36: rotation compensating frame 41: steering-body connection hole 42: fastening hole 43: side-frame support hole
51: left wheel 52: right wheel 61: support protrusion 311: inclined rotating shaft 312: vertical steering shaft 313: steering joint 321: steering-shaft insert hole
322: connection hole 323: holding cavity
324: coupling projections 325: central shaft
326: compensating plate 327: rotation transmitting cylinder 331: elastic member 332: support plate
333: pressure member 341: pressure coupling hole
342: wheel coupling member 343: central-shaft coupling hole 344: rotary support member 351: steering-body support hole
352: steering-shaft insert hole 325D: distance between central axes 3121: steering hole
3241: shock-absorbing-part connection hole
3261: plate hole 3441: catch prevention plate
341a, 341b: connecting members
343a, 343b: connecting members

### BEST MODE FOR CARRYING OUT THE INVENTION

Hereinafter, a baby carriage having a steering device according to the preferred embodiment of the present invention will be described in detail with reference to the accompanying drawings.

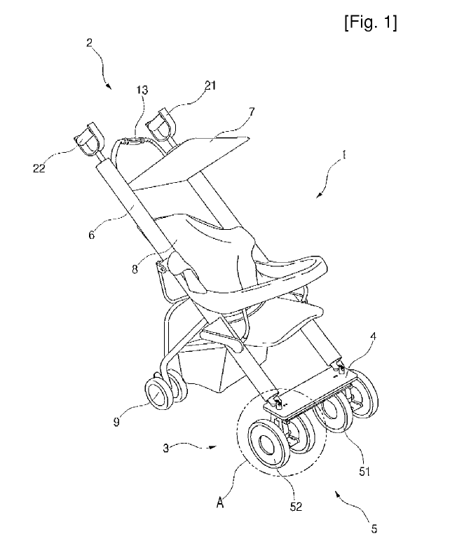

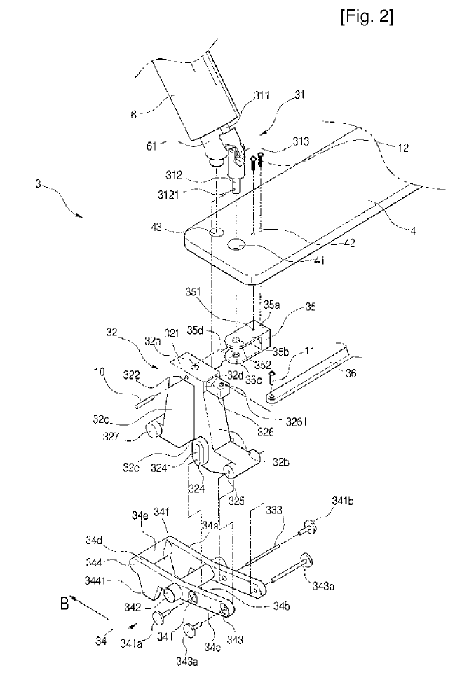

FIG. 1 is a perspective view showing a baby carriage having a steering device, according to the present invention, and FIG. 2 is an exploded perspective view of portion A, circled in FIG. 1, to show the steering device according to the present invention.

Referring to FIGS. 1 and 2, a baby carriage 1 having a steering device according to the present invention includes a pair of handles 2, a pair of steering devices 3, a pair of steering wheels 5, a support frame 4, and side frames 6. The handles 2 are grasped by a user and generate rotating force for steering. The steering devices 3 function to transmit rotating force from the handles 2. The steering wheels 5 function to steer and move the baby carriage 1, using the rotating force transmitted by the steering devices 3. A baby riding in the baby carriage 1 having the steering devices puts its feet on the support frame 4. Further, the support frame prevents the steering devices 3 from being exposed to the outside, thus providing a good appearance. The side frames 6 function to support the whole baby carriage. The baby carriage also includes a sun shade 7 that protects a baby riding in the baby carriage from direct sunlight, a cradle seat 8, in which the baby sits, and auxiliary wheels 9, which function to move the baby carriage along with the steering wheels 5 but have no steering function. Since the sun shade 7, the cradle seat 8, and the auxiliary wheels 9 are to the same as those of a general baby carriage, a detailed description of the construction thereof will be omitted herein for clarity of description.

The handles 2 are held and manipulated by a user to move the baby carriage 1 having the steering devices in a desired direction. The handles 2 comprise a pair of handles, that is, left and right handles 21 and 22. The user applies rotating force to the left and right handles 21 and 22 so as to steer the baby carriage 1 having the steering devices. If the handles 2 are constructed so as to be steered not by both a user's hands but by one hand, he or she has difficulty in controlling the total weight of the baby carriage and the baby riding in the baby carriage merely with one hand. Especially, since the baby carriage is operated mainly by women, the difficulty may be further increased. Further, when a user's eyes are directed to points other than a traveling direction, incorrect steering force may be transmitted by one hand, so that the baby carriage may move in a undesired direction. In order to solve this problem, the baby carriage of this invention is constructed to be steered by manipulating the pair of handles 2 with both hands. The left handle 21 and the right handle 22 are coupled to the corresponding steering devices 3 and the corresponding steering wheels 5, which will be described below in detail. Thus, as a user manipulates the handles with both hands, rotating forces are independently transmitted from the handles 2 to left and right sides.

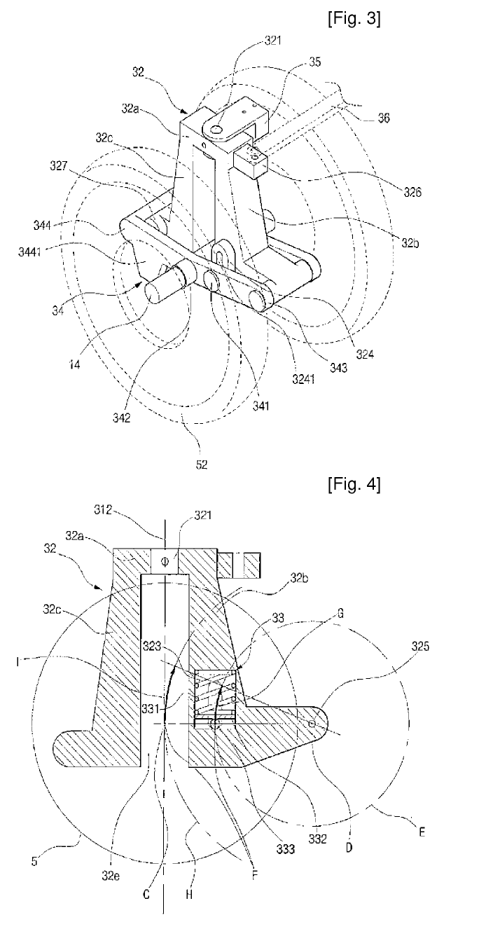

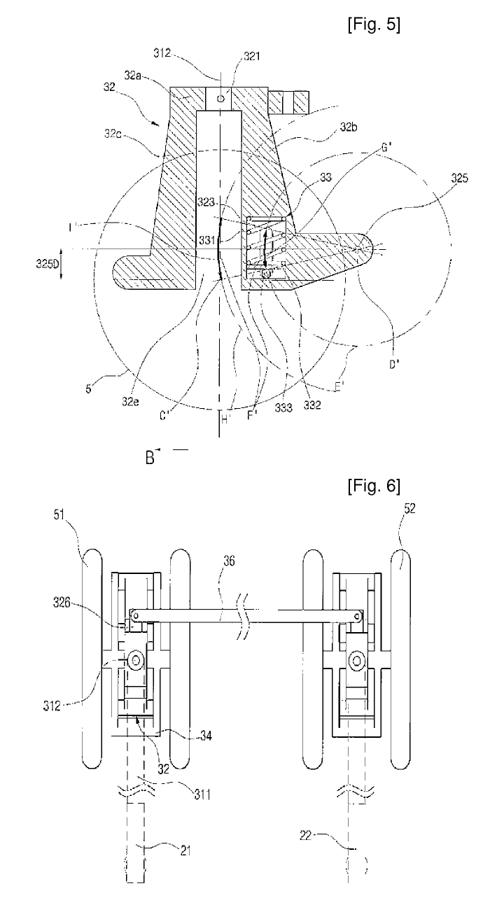

FIG. 3 is a perspective view showing a steering part and a coupling part of the baby carriage, according to the present invention, in which the steering part is coupled with the coupling part, FIG. 4 is a schematic view showing a shock absorbing state according to an embodiment of the present invention, when the central axes of a shock absorbing part and a steering wheel are on the same line, and FIG. 5 is a schematic view showing a shock absorbing state according to another embodiment of the present invention, when the central axes of a shock absorbing part and a steering wheel are spaced apart from each other by a predetermined distance.

The steering devices 3 will be described with reference to FIGS. 1 to 3 and FIG. 5. The steering devices 3 comprise a pair of steering devices, which are coupled to the left and right handles 21 and 22, respectively, and transmit rotating force from the handles 2 to the pair of steering wheels 5, which will be described below. Since the pair of steering devices 3 have the same construction, only one steering device 3 will be described below. The steering device 3 includes a steering transmission part 31, a steering body 32, a shock absorbing part 33, a coupling part 34, a clamping part 35, and a rotation compensating frame 36.

One side of the steering transmission part 31 is connected to the handle 2, while the other side thereof is connected to the steering body 32, which will be described below in detail. Thus, when a user manipulates the handle, rotating force is transmitted from the handle 2 to the steering body 32. The steering transmission part includes an inclined rotating shaft 311, a vertical steering shaft 312, and a steering joint 313.

The inclined rotating shaft 311 has the shape of an annular rod, is coupled to a rotating shaft of the steering wheel 5, and forms a predetermined inclination angle with the rotating shaft of the steering wheel, so that the rotating force is transmitted from the handle 2 to the steering wheel 5, which will be described below in detail. The handle 2 is located at the rear of the baby carriage 1, having the steering devices, thus defining a space for the cradle seat 8 in the baby carriage 1 having the steering devices, in addition to allowing a user to apply external force for moving the baby carriage 1 having the steering devices. In order to steer the baby carriage 1 having the steering devices, each of the steering wheels 5 installed at the front of the baby carriage 1 having the steering devices must be manipulated. To this end, the inclined rotating shaft 311 is coupled to the corresponding steering wheel 5 at a predetermined inclination angle.

The vertical steering shaft 312 has the shape of an elongated cylinder. One end of the vertical steering shaft is coupled to the inclined rotating shaft 311 via the steering joint 313, which will be described below in detail, while the other end of the vertical steering shaft is coupled, via the steering body 32, to the steering wheel 5, which will be described below. As a user manipulates the handle, the vertical steering shaft serves as the central rotation axis of the steering wheel 5, thus transmitting rotating force from the handle 2 to the steering wheel 5, which will be described below, therefore steering the baby carriage. The vertical steering shaft includes a steering hole 3121.

The steering hole 21 is a cylindrical through hole which passes from one side of the vertical steering shaft 312 to the other side thereof. A steering-shaft connection pin 10 is inserted into the steering hole in the vertical steering shaft 312, so that the steering body 32, which will be described below, is rotated in conjunction with the vertical steering shaft 312.

One side of the steering joint 313 is coupled to the inclined rotating shaft 311, while the other side of the steering joint is coupled to the vertical steering shaft 312. The steering joint transmits rotating force from the handle 2 through the inclined rotating shaft 311 to the steering wheel 5, which will be described below in detail, thus steering the baby carriage 1 having the steering devices. Such a steering joint 313 is coupled to the vertical steering shaft 312, which serves as the rotating axis of the steering wheel 5, which will be described below, while forming a predetermined inclination angle with the vertical steering shaft. Hence, when the central line of a driving shaft is coupled to the central line of a driven shaft at a predetermined angle of inclination, a joint capable of transmitting rotating force from the driving shaft to the driven shaft is used. Preferably, a universal joint may be used as the steering joint.

The steering body 32 is coupled to the vertical steering shaft 312 in such a way as to rotate in conjunction with the vertical steering shaft. Thus, the steering body transmits rotating force from the handle 2 to the steering wheel 5, thereby steering the baby carriage. The steering body is manufactured by assembling an upper body part 32a, a front body part 32b, and a rear body part 32c with each other. The upper body part has the shape of a rectangular plate. The front body part extends downwards a predetermined length from one end of the upper body part 32a. The rear body part extends downwards a predetermined length from the other end of the upper body part 32a. The steering body accommodates the shock absorbing part 33 (see FIG. 5), which will be described below in detail, and is coupled to the coupling part 34, thus steering the baby carriage 1 having the steering devices and absorbing some of the vibrations or shocks acting on the baby carriage when the baby carriage 1 moves on a rough road, therefore enabling stable movement of a baby, who is sensitive to the external environment. The steering body includes a steering-shaft insert hole 321, a connection hole 322, a holding cavity 323 (see FIG. 5) for accommodating the shock absorbing part, shock-absorbing-part coupling projections 324, a central shaft 325, a compensating plate 326, and a rotation transmitting cylinder 327.

The steering-shaft insert hole 321 is a through hole having a cylindrical shape, and passes from the upper surface of the upper body part 32a to the lower surface thereof. The vertical steering shaft 312 is inserted into the steering-shaft insert hole.

The connection hole 322 is a cylindrical through hole which passes from one sidewall of the upper body part 32a to the other sidewall thereof. The size of the connection hole 322 is almost the same as that of the steering hole 3121 of the vertical steering shaft 312, which is inserted into the steering-shaft insert hole 321. After the steering hole 3121 is aligned with the connection hole 322 and the vertical steering shaft 312 is inserted into the steering-shaft insert hole 321, the steering-shaft connection pin 10 is inserted into the holes. Thereby, the vertical steering shaft 312 is operated in conjunction with the steering body 32 to rotate along with the steering body.

Referring to FIG. 5, the holding cavity 323 is a predetermined space which is defined in the lower portion of the front body part 32b of the steering body 32 and has the shape of an elongated cylinder. The shock absorbing part 33, which will be described below in detail, is accommodated in the holding cavity 323, thus executing a shock absorbing operation for the baby carriage 1 having the steering devices.

Referring to FIGS. 2 and 3, the coupling projections 324 extend a predetermined length from opposite sides of the front body part 32b, and comprise hollow elliptical projections. Each coupling projection is used to couple the coupling part 34 to the shock absorbing part 33 via the steering body 32, and includes a shock-absorbing-part connection hole 3241.

The connection hole 3241 is an elliptical through hole which is formed in each coupling projection 324, and is used to couple the coupling part 34 to a pressure member 333 of the shock absorbing part 33. When the baby carriage 1 having the steering devices moves on a rough road, in which case vibration or shocks act on the baby carriage 1 from a position above or under the baby carriage, the steering body 32 or the coupling part 34, which will be described below in detail, moves up and down or rotates, and simultaneously compresses the shock absorbing part 33, thus absorbing some of the vibration or shocks. Preferably, the connection hole 3241 is larger than the pressure member 333, so as not to hinder the rotation of the coupling part 34, which will be described below, when absorbing shocks acting on the baby carriage 1 having the steering devices.

The central shaft 325 extends forwards (opposite the direction B, see FIG. 2) a predetermined length from the front body part 32b of the steering body 32, and protrudes a predetermined length from the extended portion in opposite directions, thus having the shape of a hollow cylindrical protrusion. The length of each protruding portion of the central shaft 325 is almost equal to the protruding length of the coupling projection 324. The central shaft 325 is coupled to a side of the coupling part 34, which will be described below, thus serving as a central axis around which the coupling part 34 rotates, when the shock absorbing part 33 is operated by pressing force transmitted from a lower position to the shock absorbing part 33 (see FIG. 10). Further, the shock absorbing part 33 may be operated by pressing force transmitted from the handle 2. This will be described below in detail with reference to the case where the shock absorbing part 33 of the baby carriage 1 having the steering devices is compressed downwards.

Referring to FIGS. 2 and 3, the compensating plate 326 is a rectangular plate which extends forwards (opposite direction B, see FIG. 2) a predetermined length from one end 32d (see FIG. 2) of the upper body part 32a of the steering body 32, and has a smaller sectional area than that end thereof. The compensating plate 326 couples a pair of steering devices 3 of the baby carriage 1 of this invention to each other via the rotation compensating frame 36, which will be described below in detail. Thus, when different rotating forces act on the left and right handles 21 and 22, so that different rotating angles are transmitted to a pair of steering devices 3, the compensating plate balances the rotating angles so that the steering devices 3 rotate at the same rotating angle. The compensating plate includes a plate hole 3261. Therefore, even if a user's eyes are directed to points other than a traveling direction, in which case incorrect steering force is transmitted to the left handle 21 or the right handle 22 by one hand, the rotating angle of the left or right handle 21 or 22 is corrected by the other hand, thus preventing the baby carriage from moving in an undesired direction.

The plate hole 3261 is a cylindrical through hole which passes from the upper surface of the compensating plate 326 to the lower surface thereof. The rotation compensating frame 36, which will be described below in detail, is rotatably coupled to the plate hole 3261 using a coupler 11.

The rotation transmitting cylinder 327 extends rearwards (direction B, see FIG. 2) a predetermined length from the rear body part 32c of the steering body 32, and extends a predetermined length from the extended portion in opposite directions, thus having the shape of an elongated cylinder. When rotating force for steering is transmitted to the steering body 32 to rotate it, the rotation transmitting cylinder presses the coupling part 34 according to the rotating direction, thus allowing the steering wheel 5, coupled to the coupling part 34, to be more easily rotated. As such, the rotation transmitting cylinder provides a stable steering function.

Referring to FIG. 5, the shock absorbing part 33 is held in the holding cavity 323 of the steering body 32, and functions to absorb shocks acting on the baby carriage 1 having the steering devices. When vibration or shocks act on the baby carriage 1 having the steering devices from an upper or lower position, the steering body 32 or the coupling part 34, which will be described below in detail, moves up and down or rotates, while compressing the shock absorbing part 33. At this time, the shock absorbing part 33 elastically absorbs some of the vibration or shocks. The shock absorbing part includes an elastic member 331, a support plate 332, and the pressure member 333.

One end of the elastic member 331 is supported by the holding cavity 323, while the other end thereof is supported by the support plate 332, which will be described below. Thus, when the baby carriage 1 having the steering devices according to the present invention moves on a rough road, the elastic member is compressed by external force transmitted from the handle 2 or the steering wheel 5, and is then elastically restored to its original shape when external force is eliminated. Various members, for example, a spring having a predetermined elastic force, may be used as the elastic member.

The support plate 332 has the shape of a disc. While the support plate is moved in the holding cavity 323 by the external force acting on the steering wheel 5 or the handle 2, the support plate compresses or supports one end of the elastic member 331. Meanwhile, when external force is removed from the steering wheel 5, the support plate is returned to its original position by the restoring force of the elastic member 331. As long as the support plate compresses the elastic member 331 in response to the external force acting on the steering wheel 5 or the handle 2, or is pressed by the elastic member 331 so as to be movable in the holding cavity 323, any shape of support plate is possible. In this case, it is preferable that the support plate have a shape that fits the holding cavity 323.

Referring to FIGS. 2 and 5, the pressure member 333 has the shape of an elongated cylinder, and is coupled to the coupling part 34 through the connection hole 3241. When the coupling part 34 or the steering body 32 is moved by vibration or shocks acting on the handle 2 or the steering wheel 5, which will be described below in detail, the pressure member is moved in conjunction with the coupling part 34 to press the support plate 332, or is pressed by the support plate 332, so that the elastic member 331 absorbs the vibration or shocks. Further, in order to ensure smooth rotation of the coupling part 34, which will be described below, when the shock absorbing part 33 performs a shock absorbing operation, the pressure member 333 is preferably smaller than the connection hole 3241.

Referring to FIGS. 2, 3, and 5, the coupling part 34 has the profile ‘H’, and is coupled to the steering wheel 5, which will be described below, so as to serve as a rotating axis C′ (see FIG. 5) of the steering wheel 5. One side of the coupling part is coupled to the pressure member 333 via the coupling projections 324, while another side of the coupling part is coupled to the central shaft 325. Thus, the coupling part rotates around the central axis D′ (see FIG. 5) of the central shaft 325, and the pressure member 333 is movably coupled to the coupling part. The coupling part includes pressure coupling holes 341, a wheel coupling member 342, central-shaft coupling holes 343, and a rotary support member 344.

The pressure coupling holes 341 are disc-shaped through holes which are formed in [symbol] -shaped sidewalls 34c protruding a predetermined length from both sides of an end 34b of a [symbol] -shaped body 34a of the coupling part 34 and are coupled to the pressure member 333 through the coupling projections 324, which protrude from the steering body 32 in opposite directions. Connecting members 341a and 341b are provided in the pressure coupling holes and are coupled to opposite sides of the pressure member 333. Thus, when the baby carriage 1 having the steering devices moves on a rough road and vibration or shocks act on the steering wheel 5, which will be described below, the coupling part 34 is rotated in response to the movement of the steering wheel 5, and the pressure member 333 is moved therewith, so that some of the vibration or shocks can be absorbed by the shock absorbing part 33. When vibration or shocks act on the handle 2, the coupling part 34 is rotated by the movement of the steering body 32, and the pressure member 333 is moved in conjunction with the coupling part. At this time, some of the vibration or shocks are absorbed by the shock absorbing part 33. In this way, an efficient shock absorbing operation of the baby carriage 1 having the steering devices is implemented.

Referring to FIG. 2, the wheel coupling member 342 has the shape of a hollow cylinder which protrudes a predetermined length from opposite sides of the coupling part 34, and is inserted into the opening 32e of the steering body 32. The wheel coupling member 342 is coupled to the steering wheel 5, which will be described below in detail, via an axle 14 (see FIG. 3), thus forming the same central axis C′ (see FIG. 5) as that of the steering wheel 5, and serving as the rotating shaft of the steering wheel 5.

The central-shaft coupling holes 343 are disc-shaped through holes, and are formed in the sidewalls 34c in such a way as to be spaced apart from the pressure coupling holes 341 by a predetermined distance and so as to be positioned in front of (opposite to direction B, see FIG. 2) the pressure coupling holes 341. Thus, the central-shaft coupling holes are coupled to the central shaft 325, protruding from the steering body 32 in opposite directions, via connecting members 343a and 343b. The central-shaft coupling holes 343 and the central shaft 325 are connected to each other via the connecting members 343a and 343b while forming the same central axis D′ (see FIG. 5), thus allowing the coupling part 34 to rotate around the central axis D′ (see FIG. 5) during the operation of the shock absorbing part 33. Further, the central-shaft coupling holes 343 are positioned in the front portion (opposite direction B, see FIG. 2) of the steering body 32, in the same manner as the central shaft 325. This construction allows the shock absorbing operation of the shock absorbing part 33 to be stably executed by upward pressing force acting on the baby carriage 1 having the steering devices as well as downward pressing force generated from the handle 2. This will be described in detail in the shock absorbing operation of the baby carriage 1 having the steering devices, according to the present invention.

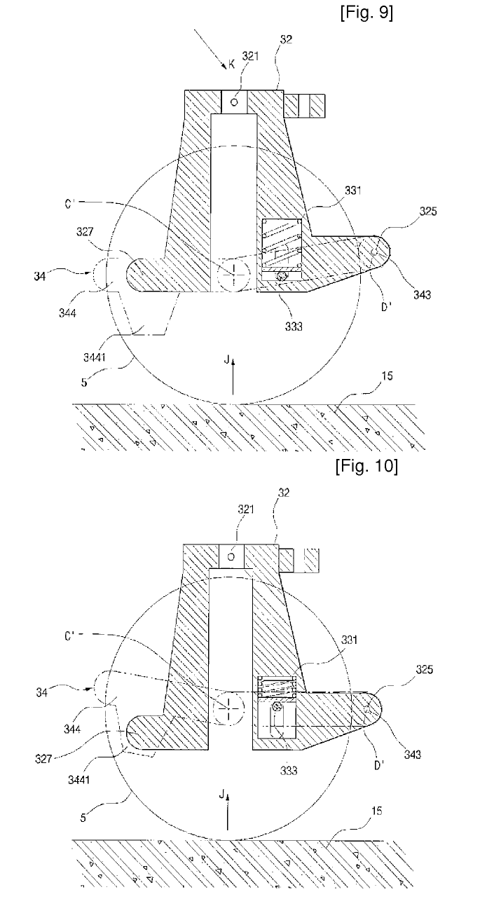

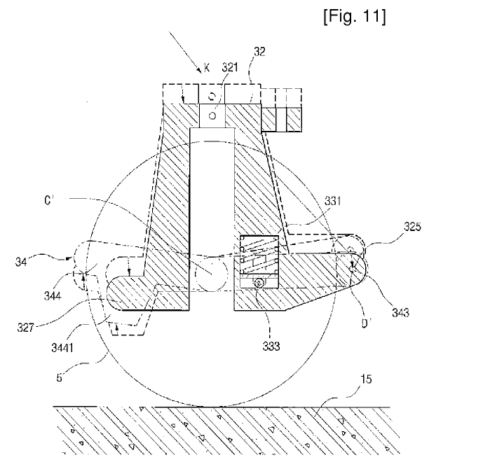

Referring to FIGS. 3 and 4, in the baby carriage 1 having the steering device according to an embodiment of the present invention, the central axis C of the wheel coupling member 342 and the steering wheel 5 may be on the same line as the central axis D of the central shaft 325 and the central-shaft coupling holes 343. Thus, when the shock absorbing part 33 is operated by pressing force transmitted from a lower position to the steering wheel 5, the coupling part 34 (see FIG. 3), moving together with the steering wheel 5, moves along a moving course G, which is directed upwards from a curvature direction conversion point F on a circle E, a radius of which is formed by coupling the central axis D of the central shaft 325 with the position of the pressure member 333, so that the elastic member 331 is compressed by the pressure member 333. As the coupling part 34 (see FIG. 3) moves, the steering wheel 5 moves along with the coupling part 34 (see FIG. 3), while the central axis C of the steering wheel 5 forming a moving course I which is directed upwards from a curvature direction conversion point F on an arc H. Thus, some of the external force is absorbed by the elastic force of the elastic member 331 provided in the shock absorbing part 33, so that the shock absorbing function is realized. Although not shown in the drawings, the shock absorbing part 33 may be operated by pressing force transmitted from the handle 2, which is positioned above the steering device 3. In this case, the steering wheel 5 is supported by the ground 15 (see FIG. 9) so that it is not moved, and the steering body 32 moves downwards. Thus, the central shaft 325 gradually moves downwards, and simultaneously the central-shaft coupling holes 343 moves downwards while rotating around the central axis C of the steering wheel 5. Thereby, the holding cavity 323 moves downwards at a speed which is faster than that of the pressure coupling holes 341 (see FIG. 3), and the elastic member 331 compresses the pressure member 333, so that some of the pressing force transmitted from the handle 2 to the steering body 32 is absorbed. In this way, the shock absorbing operation is implemented. That is, some of the pressing force transmitted from the steering wheel 5, which will be described below, is absorbed by the elastic member 331 of the shock absorbing part 33, as shown in FIG. 4, and the remaining pressing force is transmitted through the steering device 3 to the handle 2. However, since the handle 2 is grasped by a user, the movement of the handle is small. Thus, as shown in FIG. 11, the remaining pressing force moves the steering body 32 downwards, so that the elastic member 331 of the shock absorbing part 33 absorbs some of the remaining pressing force again. While this process is repeated, all of the pressing force acting on the steering device 3 is eliminated, thus enabling the stable movement of a baby riding in the baby carriage 1 having the steering devices, in addition to allowing easy steering operation.

Referring to FIGS. 3 and 5, in a baby carriage 1 having a steering device according to another embodiment of the present invention, the central axis C′ of the wheel coupling member 342 and the steering wheel 5 and the central axis D′ of the central shaft 325 and the central-shaft coupling holes 343 are not on the same line, but may be angularly spaced apart from each other by a predetermined distance 325D. That is, if the central axis C of the steering wheel 5 is on the same line as the central axis D of the central shaft 325, as shown in FIG. 4, the shock absorbing operation of the shock absorbing part 33 is executed while the steering wheel 5 moves upwards. Thus, the construction of FIG. 4 affects the shock absorbing operation and the steering operation. This will be described in detail with reference to FIG. 4. That is, when the shock absorbing part 33 is operated by pressing force transmitted from a lower position to the steering wheel 5, the coupling part 34 (see FIG. 3) moves together with the steering wheel 5 while forming the moving course G, which is directed upwards from the curvature direction conversion point F on the circle E, which is formed by coupling the central axis D of the central shaft 325 with the position of the pressure member 333 of the shock absorbing part 33. The central axis C of the steering wheel 5, which is moved along with the coupling part 34 (see FIG. 3) by the movement of the coupling part 34 (see FIG. 3), forms the moving course I, which is directed upwards from the curvature direction conversion point F on the arc H. At this time, the shock absorbing operation is executed. Thus, during the shock absorbing operation, the steering wheel 5 moves upwards, and the central axis C of the steering wheel 5 becomes distant from the vertical steering shaft 312. Thereby, when rotating force for steering is transmitted from the vertical steering shaft 312, the steering wheel 5 does not rotate around the vertical steering shaft 312, so that the expected steering effect cannot be achieved. Since the pressure member 333 presses the elastic member 331 while gradually moving away from the center of the support plate 332, which supports the elastic member 331, the compression of the elastic member 331 is insufficient to absorb pressing force, and thereby the shock absorbing effect may be deteriorated. In order to solve the problem, according to another embodiment of this invention, the central shaft 325 is positioned such that the central axis D′ of the central shaft 325 and the central axis C′ of the steering wheel 5, which will be described below, are not on the same line, but are angularly spaced apart from each other by a predetermined distance 325D, as shown in FIG. 5.

Referring to FIGS. 3 and 5, according to another embodiment of the invention, the central axis D′ of the central shaft 325 is angularly spaced apart from the central axis C′ of the steering wheel 5, which will be described below, by a predetermined distance 325D. Thus, when pressing force is transmitted from a lower position to the steering wheel 5, so that the shock absorbing part 33 is operated, the coupling part 34 moves along with the steering wheel 5 while forming a moving course G′ upwards and downwards from the curvature direction conversion point F′ on the circle E′, the radius of which is formed by coupling the central axis D′ of the central shaft 325 with the position of the pressure member 333 of the shock absorbing part 33. At this time, shocks acting on the steering wheel are absorbed by the shock absorbing part 33. As the coupling part 34 moves, the central axis C′ of the steering wheel 5, moving along with the coupling part 34, forms a moving course I′ upwards and downwards from the curvature direction conversion point F′, and the shock absorbing operation is executed. Thus, during the shock absorbing operation, the central axis C′ of the steering wheel 5 moves along the moving course I′, which is spaced from the vertical steering shaft 312 by a short distance and is very near to the vertical steering shaft 312. Thereby, even when rotating force for steering is transmitted from the vertical steering shaft 312, the steering wheel 5 performs rotation for steering while forming a steering rotating axis which is very near to the vertical steering shaft 312, regardless of the extent of motion of the steering wheel 5, so that the steering effect is maximized. The pressure member 333 may press the elastic member 331 at a position that is very near the center of the support plate 332 for supporting the elastic member 331, regardless of the extent of compression of the elastic member 331. Thus, the compression of the elastic member 331 is sufficient to absorb pressing force, so that an efficient shock absorbing function is achieved without hindering the steering function of the baby carriage 1 having the steering devices. Further, even in this case, the shock absorbing part 33 may be operated by pressing force, which is transmitted from the handle 2, which is positioned above the steering device 3. Since the central axis D′ of the central shaft 325 and the central axis C′ of the steering wheel 5, which will be described below, are angularly spaced apart from each other by a predetermined distance 325D, even when pressing force is transmitted from an upper position to the steering device 3, the steering body 32 gradually moves downwards, and the central shaft 325 and the coupling part 34 move downwards. Simultaneously, the central-shaft coupling holes 343 move downwards while rotating around the central axis C′ of the steering wheel 5. Thus, the holding cavity 323 moves downwards at a speed which is faster than that of the pressure coupling holes 341 (see FIG. 3), and the elastic member 331 compresses the pressure member 333, so that some of the pressing force transmitted from the handle 2 to the steering body 32 is absorbed. In this way, the shock absorbing operation is realized. That is, some of the pressing force transmitted from the steering wheel 5, which will be described below, is absorbed by the elastic member 331 of the shock absorbing part 33, as shown in FIG. 5, and the remaining pressing force is transmitted through the steering device 3 to the handle 2. However, since the handle 2 is grasped by a user, the movement of the handle is small. Thus, as shown in FIG. 11, the remaining pressing force moves the steering body 32 downwards, so that the elastic member 331 of the shock absorbing part 33 absorbs some of the remaining pressing force again. While this process is repeated, all of the pressing force acting on the steering device 3 is eliminated, thus enabling the stable movement of a baby riding in the baby carriage 1 having the steering devices, in addition to allowing easy steering operation. Thus, during the shock absorbing operation, the central axis C′ of the steering wheel 5 moves along the moving course I′, which is spaced from the vertical steering shaft 312 by a short distance and is very near to the vertical steering shaft 312. While the steering body 32 forms a moving course which is very near to the vertical line and minimizes forward and backward movement, a shock absorbing operation is implemented. Thus, the shock absorbing operation is efficiently carried out without hindering the steering operation.

Referring to FIGS. 2 and 3, the rotary support member 344 is constructed by coupling the [symbol] -shaped body 34a with a cylindrical rear wall 34e, which connects the ends 34d of the body to each other. The rotation transmitting cylinder 327 is held in a space 34f, which is defined by the body 34a, the rear wall 34e, and the wheel coupling member 342, so that the rotary support member is pressed and rotated by the rotation transmitting cylinder 327 during the rotation of the steering body 32. This allows the steering wheel 5, coupled to the wheel coupling member 342 of the coupling part 34, to be easily steered. The rotary support member includes catch prevention plates 3441.

Each catch prevention plate 3441 has the shape of a trapezoid, which is narrowed in a direction from an upper end thereof to a lower end thereof, and extends downwards a predetermined length from the body 34a. When the coupling part 34 or the steering body 32 is moved by the operation of the shock absorbing part 33, the catch prevention plate prevents the rotation transmitting cylinder 327, inserted into the predetermined space 34f defined by the body 34a, the rear wall 34e, and the wheel coupling member 342, from being caught by the body 34a, therefore ensuring smooth shock absorbing operation.

Referring to FIG. 2, the clamping part 35 has a V′ shape, and is manufactured by combining a rectangular body 35a with an upper plate 35b and a lower plate 35c, which extend laterally a predetermined length from upper and lower ends of the body 35a. The upper body part 32a of the steering body 32 is inserted into an opening 35d defined by the upper and lower plates 35b and 35c, and the body 35a is secured to the support frame 4, which will be described below, thus preventing the steering body 32 from shaking when the steering body is rotated for steering. The clamping part includes a steering-body support hole 351 and steering-shaft insert holes 352.

The steering-body support hole 351 is a cylindrical through hole, and passes from the upper surface of the body 35a to the lower surface thereof. The steering-body support hole is used to fasten the clamping part 35 to the support frame 4 via a fastener 12 so as to prevent the steering body 32 from shaking when the steering body rotates. As long as the hole has such a function, various shapes and numbers of holes are possible, in addition to the cylindrical through hole. Preferably, the steering-body support hole comprises two through holes, which are spaced apart from each other by a predetermined distance so that the clamping part 35 is firmly attached to the support frame 4.

Each of the steering-shaft insert holes 352 is a disc-shaped through hole. The steering-shaft insert holes are formed in the upper plate 35b and the lower plate 35c of the clamping part 35, respectively. In the state in which the upper body part 32a of the steering body 32 is inserted into the opening 35d of the clamping part 35, the vertical steering shaft 312 passes through the steering-shaft insert holes 352 and the steering-shaft insert hole 321 so as to be secured to the holes. Preferably, each steering-shaft insert hole 352 is slightly larger than the vertical steering shaft 312 so as not to hinder the rotation of the vertical steering shaft 312. Further, the opening 35d is slightly larger than the upper body part 32a, so as not to hinder the rotation of the steering body 32.

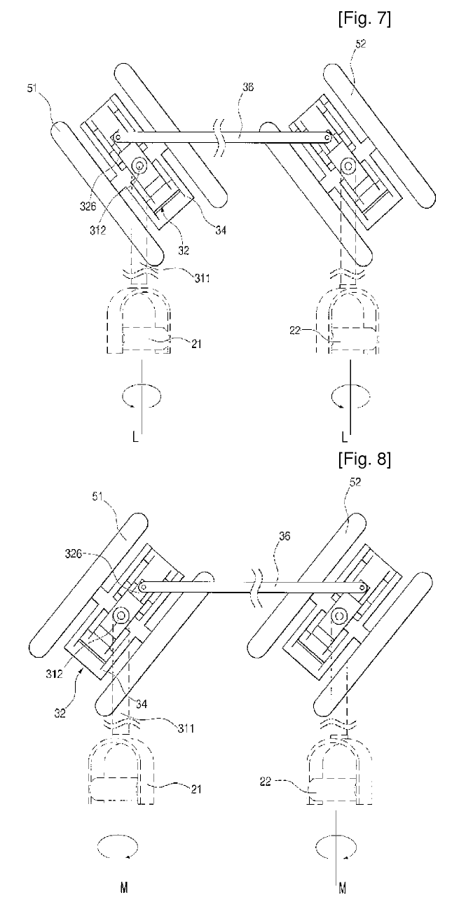

FIG. 6 is a plan view showing one use of the steering device, according to the present invention, FIG. 7 is a plan view showing another use of the steering device, according to the present invention, and FIG. 8 is a plan view showing a further use of the steering device, according to the present invention.

Referring to FIGS. 2, 3, and 5, the rotation compensating frame 36 is coupled to the compensating plate 326 of the steering body 32 to balance the rotating forces and rotating angles which are applied to the pair of steering devices 3. Thereby, the steering wheels 5 rotate at the same rotating angle, thus allowing the baby carriage 1 having the steering devices to be stably steered. Therefore, even if a user transmits incorrect steering force to the left handle 21 or the right handle 22 by one hand, the rotating angle is corrected using the left handle 21 or the right handle 22 grasped by the other hand, thus preventing the baby carriage from moving in an undesired direction.

Referring to FIGS. 1 and 2, the support frame 4 has the shape of a rectangular plate. A baby riding in the baby carriage 1 having the steering devices may put its feet on the support frame. The support frame has a size which prevents each steering device 3 from being exposed to the outside, thus providing a good appearance to the baby carriage 1 having the steering devices. The support frame couples each steering device 3 to the handle 2, and includes steering-body connection holes 41, fastening holes 42, and side-frame support holes 43.

Each steering-body connection hole 41 is a through hole, into which an end of the steering joint 313 of the steering transmission part 31 is inserted in such a way that the vertical steering shaft 312 protrudes downwards from the support frame 4. Preferably, the steering-body connection hole 41 has a size similar to that of the steering joint 313 so as to prevent the steering joint 313 from shaking when the steering joint rotates, in addition to ensuring smooth rotation of the steering joint 313.

Each fastening hole 42 is a through hole, through which the fastener 12 passes to be fastened to the steering-body support hole 351 of the clamping part 35. Through such a fastening operation, the clamping part 35 is firmly secured to the support frame 4, thus preventing the steering body 32, coupled to the clamping part 35, from shaking during rotation.

Each side-frame support hole 43 is a disc-shaped through hole. A support protrusion 61 of the side frame 6 is inserted into the side-frame support hole, thus firmly holding the support frame 4.

Referring to FIGS. 1 to 3, the steering wheel 5 comprises a pair of wheels which are coupled to the handles 2 through the steering devices 3, that is, a left wheel 51 and a right wheel 52, which are coupled to the left handle 21 and the right handle 22, respectively, and functions to move and steer the baby carriage 1 having the steering devices. If these steering wheels 5 are constructed so that the baby carriage is steered not by a pair of steering wheels but by one steering wheel, he or she has difficulty in controlling the total weight of the baby carriage and the baby riding in the baby carriage merely with one hand. Especially, since the baby carriage is operated mainly by women, the difficulty may be further increased. Further, when a user's eyes are directed to points other than a traveling direction, incorrect steering force may be transmitted by one hand, so that the baby carriage may move in a undesired direction. In order to solve this problem, the baby carriage of this invention is constructed to be steered by a pair of steering wheels 5. Further, the rotating forces are independently transmitted from the left and right handles 21 and 22 to the left and right wheels 51 and 52. Moreover, the steering wheel 5 is not directly connected to the steering body 32, but is connected to the steering body through the wheel coupling member 342 of the coupling part 34 and the axle 14 (see FIG. 3). That is, the steering wheel is coupled to the steering body 32 through the coupling part 34. As described above, since the central axis C′ (see FIG. 5) of the steering wheel 5 and the central axis D′ (see FIG. 5) of the central shaft 325 are angularly spaced apart from each other by a predetermined distance 325D, a stable shock absorbing operation is achieved without hindering the steering operation of the steering device 3. Meanwhile, both the left wheel 51 and the right wheel 52 are coupled to the corresponding steering bodies via the wheel coupling member 342, protruding from opposite sides of the coupling part 34 and the axle 14 (see FIG. 3), so that each wheel rotates around the central axis C′ (see FIG. 5) of the wheel coupling member 342 to move the baby carriage 1 having the steering devices. Preferably, the wheel comprises a pair of wheel parts.

Referring to FIGS. 1 and 2, each side frame 6 has the shape of a hollow annular rod, and accommodates the inclined rotating shaft 311 therein so that the inclined rotating shaft 311 is not exposed to the outside, thus providing a good appearance. The inclined rotating shaft 311 is coupled to the handle 2 at one end of the side frame 6, while the inclined rotating shaft 311 is coupled to the steering joint 313 at the other end of the side frame. The side frame includes the support protrusion 61.

The support protrusion 61 is the part of the side frame 6 that is coupled at one end thereof to the support frame 4 and is coupled at the other end thereof to the side frame 6, thus serving to couple the support frame 4 to the side frame 6. The support protrusion is inserted into the side-frame support hole 43 of the support frame 4, thus firmly coupling the support frame 4 with the side frame 6. Meanwhile, according to another embodiment of the invention, as long as the support frame 4 is firmly coupled with the side frame 6, structures other than the support protrusion 61 may be used. For example, the side frame 6 may be firmly coupled to the support frame 4 using an additional fastening means.

According to a further embodiment of the invention, the baby carriage 1 having the steering devices may also include a connection bar 13, as shown in FIG. 1. The connection bar 13 functions to connect a pair of side frames 6 to each other. Such a connection bar 13 prevents the side frames 6 from shaking when each inclined rotating shaft 311 is rotated by the manipulation of the handle 2. Further, a user can easily move the baby carriage 1 back and forth without steering the baby carriage, by grasping the connection bar 13.

Hereinafter, the construction and operation of the baby carriage having the steering devices according to the preferred embodiment of the present invention will be described in detail with reference to the accompanying drawings.

Referring to FIGS. 1 to 8, the operation of the baby carriage 1 having the steering devices according to the invention is as follows.

Referring to FIG. 6, when a user desires to move the baby carriage 1 having the steering devices without steering, the left handle 21 and the right handle 22 are not rotated leftwards and rightwards, but are oriented straight. Thereby, a pair of steering bodies 32 and coupling parts 34 and the left and right wheels 52 are arranged in the same direction. Therefore, the baby carriage 1 having the steering devices can be moved back and forth by the external force of a user.

Referring to FIGS. 1, 2, and 7, when a user rotates the handles 2 counterclockwise (direction L) to steer the baby carriage 1 having the steering devices, the left handle 21 and the right handle 22 are rotated counterclockwise (direction L) by the rotating force and rotating angles generated by the user's both hands.

As the left handle 21 and the right handle 22 rotate, the pair of inclined rotating shafts 311 is rotated in the same direction and at the same rotating angle as the left handle 21 and the right handle 22.

Rotating force is transmitted from each inclined rotating shaft 311 through the steering joint 313 to the vertical steering shaft 312, so that the vertical steering shaft 312 rotates in the same direction and at the same rotating angle as the handle 2. Preferably, the steering joint 313 comprises a universal joint that stably transmits rotating force from the inclined rotating shaft 311, which serves as a driving shaft and is coupled to the vertical steering shaft 312, at a predetermined inclination angle, to the vertical steering shaft 312, which serves as a driven shaft.

Each steering body 32, which is coupled to the vertical steering shaft 312 via the steering-shaft connection pin 10 in such a way as to rotate in conjunction with the vertical steering shaft, rotates in the same direction and at the same rotating angle as the handle 2. The steering wheel 5, coupled to the steering body 32 via the coupling part 34, also rotates in the same direction and at the same rotating angle. In this way, the baby carriage 1 having the steering devices is steered. In this case, a pair of steering bodies 32 is coupled to the rotation compensating frame 36 via the compensating plates 326. Thus, even when different rotating forces and rotating angles are provided to the left handle 21 and the right handle 22, the rotating forces and rotating angles to be transmitted to the left wheel 51 and the right wheel 52 are balanced. Thereby, the wheels are steered with the same rotating force and at the same rotating angle, thus stably steering the baby carriage.

Referring to FIGS. 1, 2, and 8, when a user rotates the handles 2 clockwise (direction M), the operation of steering the baby carriage is carried out in a manner similar to the operation which is performed when the user rotates the handles 2 counterclockwise (direction L, see FIG. 7), so that the baby carriage 1 having the steering devices is steered in a desired direction. Further, when each steering body 32 rotates, the rotation transmitting cylinder 327 compresses the rotary support member 344, thus affording easier steering of the steering wheel 5 coupled to the coupling part 34.

The shock absorbing operation of the baby carriage having the steering devices according to the preferred embodiment of the present invention will be described below in detail with reference to the accompanying drawings.

FIG. 9 is a schematic view showing the state before the shock absorbing part of the present invention is operated, FIG. 10 is a schematic view showing the operational state when the shock absorbing part of the present invention is compressed upwards, and FIG. 11 is a schematic view showing the operational state when the shock absorbing part of the present invention is compressed downwards.

Referring to FIGS. 3 and 9, in the baby carriage 1 having the steering devices according to the present invention, the following state is maintained before each shock absorbing part 33 is operated.

Each steering wheel 5 is coupled to the wheel coupling member 342 of the coupling part 34 through the axle 14.

The pressure coupling holes 341 of the coupling part 34 are coupled to the pressure member 333 through the coupling projections 324. The central shaft 325 is rotatably coupled to the central-shaft coupling holes 343. Further, the rotation transmitting cylinder 327 is positioned in the rotary support member 344.

Referring to FIGS. 3 and 10, in the baby carriage 1 having the steering devices according to the present invention, the operation of the baby carriage is as follows when the shock absorbing part 33 is compressed from a lower position.

Each steering wheel 5 is moved upwards J by pressing force transmitted from the ground 15.

The coupling part 34, coupled to the steering wheel 5, moves around the central axis D′ of the central-shaft coupling holes 343.

As the coupling part 34 moves, the pressure member 333, coupled to the pressure coupling holes 341, moves therewith. At this time, some of the pressing force transmitted from the ground 15 to the steering wheel 5 is absorbed by the elastic member 331, and shocks are absorbed.

When the rotary support member 344 moves, the catch prevention plates 3441 prevent the rotation transmitting cylinder 327 from moving outside the catch prevention plates 3441. Thus, even when pressing force transmitted to the steering wheel 5 is eliminated later, the rotation transmitting cylinder is not caught by the body 34a (see FIG. 2), so that a stable shock absorbing operation is carried out.

In this case, as shown in FIG. 5, the central axis D′ of the central-shaft coupling holes 343 is angularly spaced apart from the central axis C′ of the steering wheel 5 by a predetermined distance 325D. Thus, the coupling part 34 moves along the moving course I′, obtained when the steering wheel 5 rectilinearly moves up and down. Therefore, during the operation of the shock absorbing part 33, the shaking of the steering body 32 is minimized, so that a stable steering and moving operation is accomplished.

Referring to FIGS. 3 and 11, in the baby carriage 1 having the steering devices according to the present invention, the baby carriage is operated as follows when the shock absorbing part 33 is compressed from an upper position.

That is, when pressing force is transmitted obliquely and downwards (direction K) from each handle 2, the steering wheel 5 is supported on the ground 15, but is not moved. Thereby, the steering body 32 moves downwards.

At this time, the central shaft 325 moves downwards, and simultaneously, the central-shaft coupling holes 343 rotate around the central axis C′ of the steering wheel 5 and thus move downwards.

As the central shaft 325 moves, the holding cavity 323 moves downwards. Due to the movement of the central-shaft coupling hole 343, the pressure coupling holes 341 (see FIG. 3) also move downwards.

In this case, the holding cavity 323 moves downwards at a speed which is faster than that of the pressure coupling hole 341 (see FIG. 3). The elastic member 331 compresses the pressure member 333, while some of the pressing force transmitted from the handle 2 to the steering body 32 is absorbed, and shocks are absorbed.

As the coupling part 34 and the steering body 32 move, the rotation transmitting cylinder 327 and the rotary support member 344 move along with the coupling part and the steering body. The catch prevention plates 3441 of the rotary support member prevent the rotation transmitting cylinder 327 from moving outside the catch prevention plates 3441. Thereby, even when pressing force, transmitted to the handle 2, is subsequently eliminated, the rotation transmitting cylinder is not caught by the body 34a (see FIG. 2), so that the shock absorbing operation is stably performed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A baby carriage having a steering device, comprising: a pair of handles manipulated by a user to generate rotating force for steering; a pair of steering wheels rotated in conjunction with the handles, and used to steer and move the baby carriage; and a pair of steering devices transmitting the rotating force from the handles to the steering wheels, wherein each of the steering devices comprises: a vertical steering shaft coupled to each of the steering wheels; an inclined rotating shaft coupled at a first end thereof to each of the handles, and coupled at a second end thereof to the vertical steering shaft while being inclined relative to the vertical steering shaft at a predetermined inclination angle; a steering joint transmitting rotating force from the inclined rotating shaft to the vertical steering shaft, so that each of the steering wheels is steered; and a shock absorbing part absorbing an external force acting on each of the steering wheels, thus enabling a baby riding in the baby carriage to be stably moved.

2. The baby carriage according to claim 1, wherein the steering device comprises: a steering body comprising a holding cavity provided in a predetermined portion of the steering body to accommodate the shock absorbing part therein, and a central shaft provided at a predetermined position around the holding cavity and coupled to a central axis of the shock absorbing part; and a coupling part coupled at a first side thereof to the holding cavity via a coupling projection, and coupled at a second side thereof to the central shaft, so that, when external force is applied to the steering device, the coupling part rotates and compresses the shock absorbing part to absorb the external force.

3. The baby carriage according to claim 2, wherein the coupling part comprises: a pressure coupling hole coupled to the coupling projection; a central-shaft coupling hole coupled to the central shaft; and a wheel coupling member coupled to the steering wheel, the wheel coupling member being spaced apart from the central-shaft coupling hole by a predetermined distance so that, when external force is applied to the steering device, the wheel coupling member rotates and reduces a distance by which it is spaced apart from the vertical steering shaft.

4. The baby carriage according to claim 2, wherein the shock absorbing part comprises: an elastic member having elastic force to absorb external force transmitted through the coupling part; a support plate supporting an end of the elastic member to press the elastic member; and a pressure member coupled to the coupling part via the coupling projection, and moving along with the coupling part to press the support plate.

5. The baby carriage according to claim 2, wherein the steering body further comprises: a compensating plate coupled to a rotation compensating frame which balances different rotating forces transmitted to the respective steering wheels so that the pair of steering wheels rotates at the same rotating angle.

6. The baby carriage according to claim 1, further comprising: a support frame on which a baby riding in the baby carriage puts its feet, the support frame preventing the steering device from being exposed to the outside, thus providing a good appearance.

7. The baby carriage according to claim 2, wherein the steering device further comprises: a clamping part through which the vertical steering shaft passes, the clamping part rotatably supporting the steering body.

8. The baby carriage according to claim 2, wherein the steering body comprises: a connection hole into which a steering-shaft connection pin is inserted, so that the steering body rotates in conjunction with the vertical steering shaft.

9. The baby carriage according to claim 2, wherein the steering body comprises: a rotation transmitting cylinder used to transmit rotating force from the handle through the coupling part to the steering wheel, the coupling part comprising a rotary support member supported by the rotation transmitting cylinder, the rotary support member further comprising a catch prevention plate to prevent the rotation transmitting cylinder from being caught by the rotary support member when the coupling part moves during a shock absorbing operation.

10. The baby carriage according to claim 1, wherein the steering joint comprises a universal joint.

11. The baby carriage according to claim 2, wherein the steering joint comprises a universal joint.

12. The baby carriage according to claim 3, wherein the steering joint comprises a universal joint.

13. The baby carriage according to claim 4, wherein the steering joint comprises a universal joint.

14. The baby carriage according to claim 5, wherein the steering joint comprises a universal joint.

15. The baby carriage according to claim 6, wherein the steering joint comprises a universal joint.

16. The baby carriage according to claim 7, wherein the steering joint comprises a universal joint.

17. The baby carriage according to claim 8, wherein the steering joint comprises a universal joint.

18. The baby carriage according to claim 9, wherein the steering joint comprises a universal joint.
